(19) United States
(12) Patent Application Publication
(10) Pub. No.: US 2005/0007473 A1
(43) Pub. Date: Jan. 13, 2005

(54) Reducing image sensor lag

(76) Inventors: Jeremy A. Theil, Mountain View, CA (US); James P. Roland, Ft. Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/615,522

(22) Filed: Jul. 8, 2003

(51) Int. Cl. H04N 5/335

(52) U.S. Cl. 348/308; 348/294

(57) ABSTRACT

Systems and methods of reducing image sensor lag are described. In one aspect, an image sensor includes multiple pixels, pixel circuits, and a bias circuit. Each of the pixels includes a respective photodiode region. Each of the pixel circuits is operable to control integration and readout steps for a respective pixel. The bias circuit is operable to apply voltages across the pixels to induce carrier injection into the photodiode regions to reduce image lag. In another aspect, non-reverse-bias flow of carriers is induced in the photodiode regions of image sensor pixels to reduce image lag.

### TECHNICAL FIELD

This invention relates to systems and methods of reducing image sensor lag.

### BACKGROUND

Image sensors typically include a one-dimensional linear array or a two-dimensional array of light sensitive regions (often referred to as “pixels”) that generate electrical signals that are proportional to the intensity of the light respectively received in the light sensitive regions. Solid-state image sensors are used in a wide variety of different applications, including digital still cameras, digital video cameras, machine vision systems, robotics, guidance and navigation applications, and automotive applications.

One class of image sensors is based on charge-coupled device (CCD) technology. In a common implementation, a CCD image sensor includes an array of closely spaced metal-oxide-semiconductor (MOS) diodes. In operation, a sequence of clock pulses is applied to the MOS diodes to transfer charge across the imaging area.

Another class of image sensors is based on active pixels sensor (APS) technology. Each pixel of an APS image sensor includes a light sensitive region and sensing circuitry. The sensing circuitry includes an active transistor that amplifies and buffers the electrical signals generated by the associated light sensitive region. In a common implementation, APS image sensors are made using standard complementary metal-oxide-semiconductor (CMOS) processes, allowing such image sensors to be readily integrated with standard analog and digital integrated circuits.

In a common three-transistor (3T) design, a CMOS APS image sensor pixel includes an imaging device (e.g., a photodiode), a source follower transistor, a readout transistor, and a row selection transistor. In a typical mode of operation, the imaging device initially is reset during a reset step by making the sensing node of a pixel high. Next, during an integration step, the photogenerated charge recombines with the stored charge on the photodiode, thus discharging the photodiode and lowering the sense (or source follower) voltage. When a pixel is accessed during a readout step, the voltage at the source follower transistor gate is sampled, then the pixel is reset and the voltage at the readout transistor is sampled again. The difference between the two sampled voltages corresponds to the intensity of light impinging on the pixel.

In some circumstances, the difference in the sampled readout voltages does not correspond to the actual accumulated signal. For example, if a pixel is bright in one image frame and dark in the next image frame, the measured voltage difference may be higher than the actual accumulated signal because the reset pulse applied during the initial reset step for the second image frame may not pull the voltage at the readout transistor gate up to the high level due to incomplete charge extraction or fluctuations in the supply voltage. Similarly, if a pixel is dark in one image frame and bright in the next image frame, the measured voltage difference may be lower than the actual accumulated signal because the reset pulse applied after the first readout step for the second image frame may not pull the voltage at the readout transistor gate up to the high level. In these exemplary circumstances, it may take several image frames before the measured signal corresponds to the actual accumulated signal. This delay often is referred to as “image lag”.

### SUMMARY

The invention features systems and methods of reducing image sensor lag.

In one aspect, the invention features an image sensor that includes multiple pixels, pixel circuits, and a bias circuit. Each of the pixels includes a respective photodiode region. Each of the pixel circuits is operable to control integration and readout steps for a respective pixel. The bias circuit is operable to apply voltages across the pixels to induce carrier injection into the photodiode regions to reduce image lag.

In another aspect, the invention features a method of operating an image sensor that includes multiple pixels, each of which includes a respective photodiode region. In accordance with this inventive method, photodiode regions are reset, charges in photodiode regions are integrated, pixel nodes are sampled, and carrier injection is induced into the photodiode regions to reduce image lag.

Other features and advantages of the invention will become apparent from the following description, including the drawings and the claims.

### DESCRIPTION OF DRAWINGS

FIG. 1 is a diagrammatic side view of a portion of an image sensor.

FIG. 2 is a diagrammatic top view of a portion of the image sensor of FIG. 1.

FIG. 3 is a circuit diagram of a bias circuit connected to a pixel circuit for a pixel of the image sensor of FIG. 1.

FIG. 4 is a flow diagram of a method of operating the image sensor of FIG. 1.

FIG. 5 is a diagrammatic side view that shows the reverse bias flow of carriers in the photodiode regions of the image sensor of FIG. 1.

FIG. 6 is a diagrammatic side view that shows the forward bias flow of carriers injected into the photodiode regions of the image sensor of FIG. 1.

FIG. 7 is a graph of photodiode current plotted as a function of time for different photodiode bias voltages.

FIG. 8 is a graph of an image lag time plotted as a function of bias across a photodiode region of the image sensor of FIG. 1.

FIG. 9A is a diagrammatic side view that shows the injection of carriers between photodiode regions of adjacent pixels of the image sensor of FIG. 1 that are biased with two separate bias lines.

FIG. 9B is a diagrammatic side view that shows the injection of carriers between photodiode regions of adjacent pixels of the image sensor of FIG. 1 that are biased with a single bias line and a set of resistive elements coupled in parallel between the bias line and alternate pixels.

FIG. 10 is a graph of photodiode leakage current plotted as a function of time for different inter-pixel bias voltages.

FIG. 11 is a graph of a computed characteristic decay time plotted as a function of inter-pixel bias difference.

FIG. 12A is a diagrammatic top view of the image sensor of FIG. 1 showing different relative inter-pixel biases applied between pixels in adjacent rows and adjacent columns.

FIG. 12B is a diagrammatic top view of the image sensor of FIG. 1 showing different relative inter-pixel biases applied between adjacent pixels in adjacent rows.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

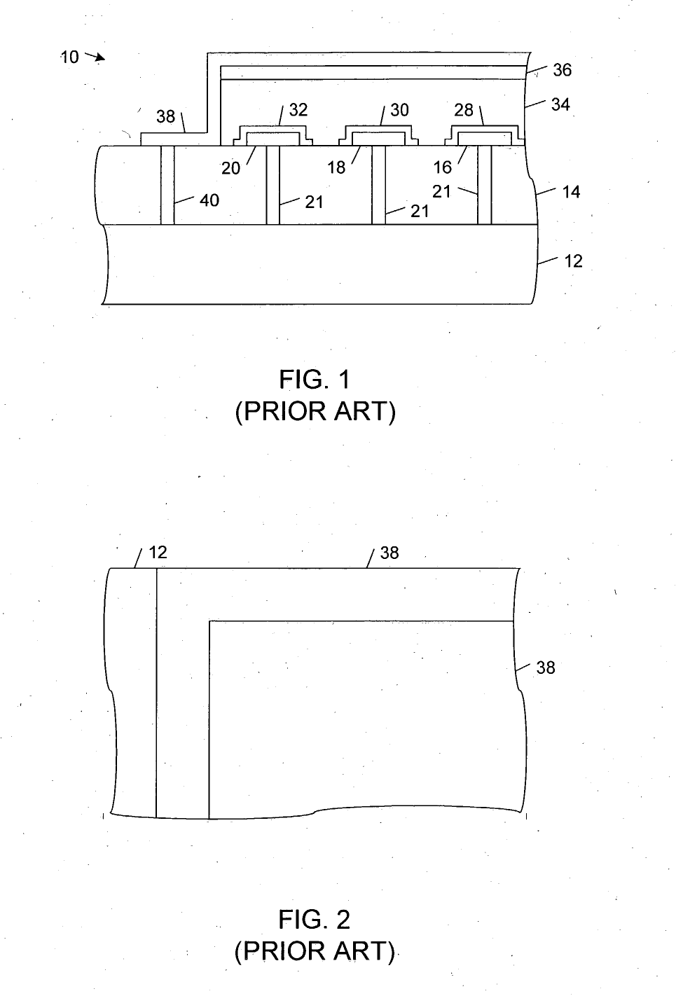

FIGS. 1 and 2 show an embodiment of an image sensor 10 that includes a substrate 12 that includes electronic circuitry (not shown), an interconnection structure 14, and multiple pixel electrodes 16, 18, 20, that are coupled to the electronic circuitry in the substrate 12 by electrically conductive vias 21 extending through the interconnection structure 14. Each of the pixel electrodes 16-20 is formed adjacent to a respective p-i-n photodiode region of a respective pixel. Each photodiode region includes a respective n-type region 28, 30, 32, an intrinsic (or i-) layer 34, and a p-type layer 36. An electrically conductive layer 38 is formed over the p-type layer 36. Electrically conductive layer 38 is electrically connected to the circuitry in the substrate 12 by an electrically conductive via 40. Electrically conductive layer 38 is substantially transparent and allows incoming light to reach the photodiode regions.

Substrate 12 may be a semiconductor substrate (e.g., silicon) and the electronic circuitry that is formed in substrate 12 may be fabricated in accordance with any semiconductor device fabrication process, including CMOS, bipolar CMOS (BiCMOS), and bipolar junction transistor fabrication processes. A variety of different types of devices may be formed in substrate 12. The electrically conductive vias 21, 40 that extend through the interconnect structure 14 are filled with an electrically conductive material (e.g., tungsten, copper, or aluminum). The pixel electrodes also are formed from an electrically conductive material (e.g., tungsten, copper, or aluminum). The n-type regions 28-32 may be formed from a semiconductor material (e.g., amorphous silicon, amorphous carbon, amorphous silicon carbide, amorphous germanium, or amorphous silicon-germanium) that is doped n-type (e.g., doped with phosphorous in the case of amorphous silicon). The i-layer 34 may be formed of a semiconductor material (e.g., hydrogenated amorphous silicon, amorphous carbon, amorphous silicon carbide, amorphous germanium, or amorphous silicon-germanium) that has a thickness on the order of about 1 micrometer. The p-type layer 36 may be formed of a semiconductor material (e.g., amorphous silicon, amorphous carbon, amorphous silicon carbide, amorphous germanium, or amorphous silicon-germanium) that is doped p-type (e.g., doped with boron in the case of amorphous silicon). The electrically conductive layer 38 is formed of an electrically conductive material that is opaque to light with a wavelength within a target wavelength range. In some implementations, the electrically conductive layer may be formed of indium-tin-oxide or zinc oxide.

Additional details regarding the structure, operation, and alternative implementations of image sensor 10 may be obtained from U.S. Pat. Nos. 6,396,118 and 6,018,187, which are incorporated herein by reference.

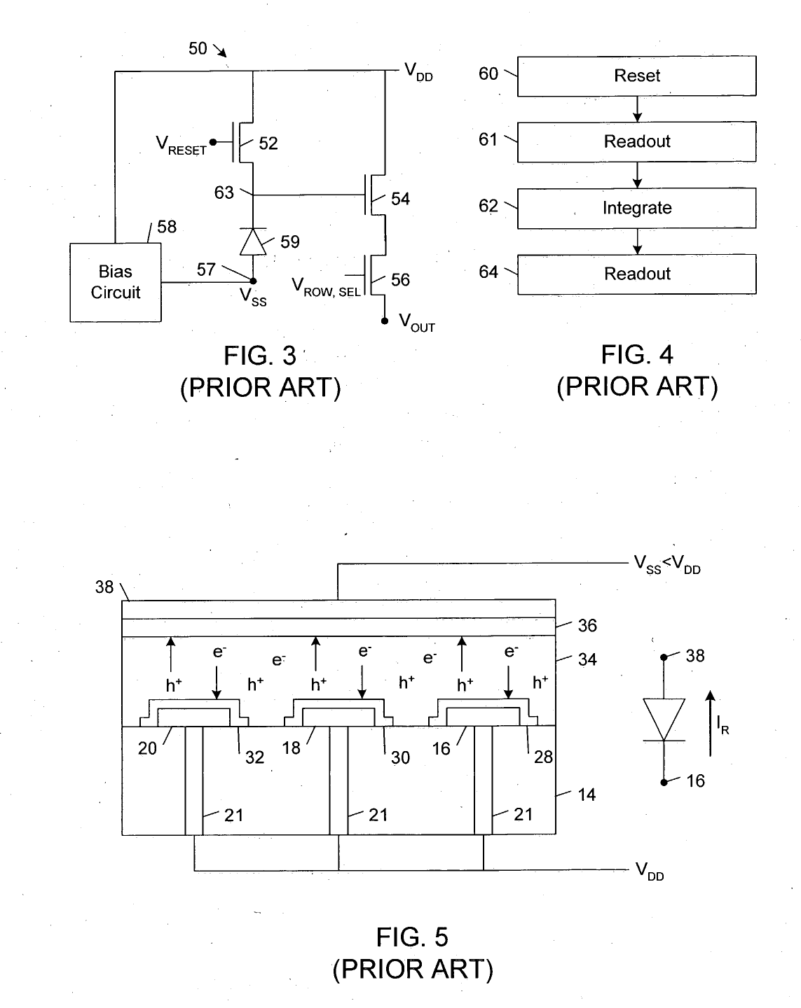

FIG. 3 shows an exemplary pixel circuit 50 for a pixel photodiode region of the image sensor 10. Pixel circuit 50 includes a reset transistor 52, a source-follower transistor 54, and a row select transistor 56. The drains of the reset and source-follower transistors 52, 54 are electrically connected to a high voltage rail (V_{DD}) of a bias circuit 58. The anode 57 of the photodiode 59 is electrically connected to the low voltage rail (V_{SS}) of the bias circuit 58. The gates of the reset and row select transistors 52, 56 are controlled by control signals V_{RESET} and V_{ROW, SEL}, respectively.

FIG. 4 shows a cycle of a prior art correlated double-sampling mode of operating image sensor 10. In this prior art approach, the voltage applied across the pixels by the bias circuit 58 is a fixed reverse bias voltage (i.e., V_{DD} and V_{SS} are fixed and V_{DD}>V_{SS}). Initially, the photodiode 59 is reset by setting V_{RESET} high (step 60). In response, sample node 63 is pulled to a high reverse bias voltage (e.g., to a value of V_{DD}). After being reset (step 60), the voltage at the sample node 63 is sampled and the readout voltage is stored (step 61). Next, the charge of charge carriers (electron-hole pairs) that are generated in the photodiode 59 is integrated (step 62). The accumulated charge reduces the reverse-bias voltage across the photodiode 59. When the pixel is accessed for readout (step 64), the voltage at the sample node 63 is sampled. The difference between the voltages sampled in readout steps 61 and 64 corresponds to the brightness of the pixel.

In an uncorrelated double-sampling mode of operating image sensor 10, the voltage sampled in the readout step 61 in a current cycle of the process of FIG. 4 is subtracted from the voltage sampled in readout step 64 of the preceding cycle to determine the brightness of the pixel in the preceding cycle.

As explained, above, the voltage at the sample node 63 at the end of the integration period depends on the duration of the reset signal applied during the reset step 60 and the initial voltage of the sample node 63 at the beginning of the reset step 60. In some circumstances, the difference in the sampled readout voltages does not correspond to the actual accumulated signal. For example, if a pixel is bright in one image frame and dark in the next image frame, the measured voltage difference may be higher than the actual accumulated signal because the reset signal (V_{RESET}) applied during the reset step 60 for the second image frame may not completely charge the photodiode region and thereby pull the voltage at the sample node 63 up to the high level (e.g., V_{DD}). In this exemplary circumstance, it may take several image frames before the measured signal corresponds to the actual accumulated signal. This delay often is referred to as “image lag”.

FIG. 5 shows the flow of photogenerated charge carriers (electrons are denoted by “e”, and holes are denoted by “h⁺”) during the operating cycle described above in connection with FIG. 4. In this method of operation, the bias circuit 58 applies fixed rail voltages (V_{DD} and V_{SS}, with V_{SS}<V_{DD}) that maintain the photodiode 59 in reverse bias throughout the operating cycle. Accordingly, the photogenerated holes (h⁺) are drawn to the p-type layer 36 and the photogenerated electrons (e⁻) are drawn to the n-type regions 28, 30, 32. In this method of operation, carrier mobility effects have been observed to contribute to image lag. In particular, in some material systems (e.g., material systems with high trap densities, such as amorphous silicon based material systems), the mobility of holes is substantially slower than electron mobility. Such slow hole mobility limits the rate at which the photodiode 59 may be charged (or turned off) during reset.

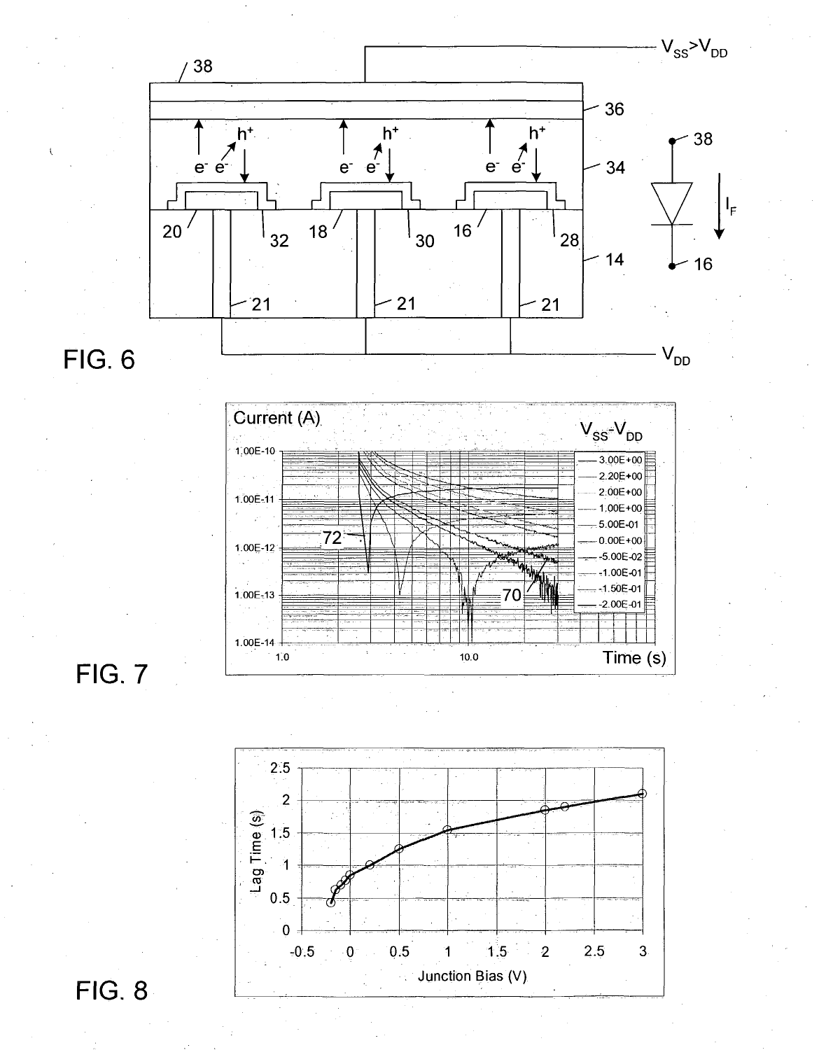

FIG. 6 shows the flow of photogenerated charge carriers (e⁻, h⁺) in an embodiment in which the bias circuit 58 induces carrier injection into the photodiode regions to reduce image lag. In this embodiment, the bias circuit 58 applies a forward bias (V_{SS}>V_{DD}) across the pixels to induce a forward bias flow of injected carriers through the pixel photodiode regions. The applied forward bias floods all of the photodiode regions, including the inter-pixel photodiode regions, with electrons that annihilate the remaining holes. In this way, the residual-charge caused by the holes may be eliminated rapidly.

The measurement results of FIGS. 7 and 8 show that, in some implementations, image lag may be reduced from about 30 seconds to a fraction of a second by applying a forward bias of only a few hundred millivolts. In particular, FIG. 7, shows that the photodiode turn-off time constant corresponding to the slope of the initial current drop increases as the magnitude of the forward bias current (V_{DD}−V_{SS}<0) is increased from zero volts (0.00E+00; line 70) to 200 millivolts (−2.00E−1; line 72). It is noted that the subsequent rise in current for each curve is due to the continuing injection of charge into the junction. Once the residual charge is removed, the additional injected charge is collected by the opposite electrode and is registered as additional current. FIG. 8 shows that the image lag time decreases exponentially as the magnitude of the forward bias (negative junction bias in the graph) increases.

The forward bias charge blanking embodiment described above may be readily incorporated into the image sensor operating method of FIG. 4. For example, in some implementations, bias circuit 58 may apply a forward (or blanking) bias across pixels of image sensor 10 during the reset step (step 60) or during a separate charge blanking step. In some implementations, all of the pixels of sensor 10 may be forward biased periodically (e.g., during each operating cycle, or less frequently). In these implementations, the image sensor pixels may be forward biased row-by-row, in accordance with a row-by-row reset, readout, integration, and readout cycle, or all at the same time. In other implementations, only a subset of the image sensor pixels is forward biased either randomly or as needed to reduce image lag.

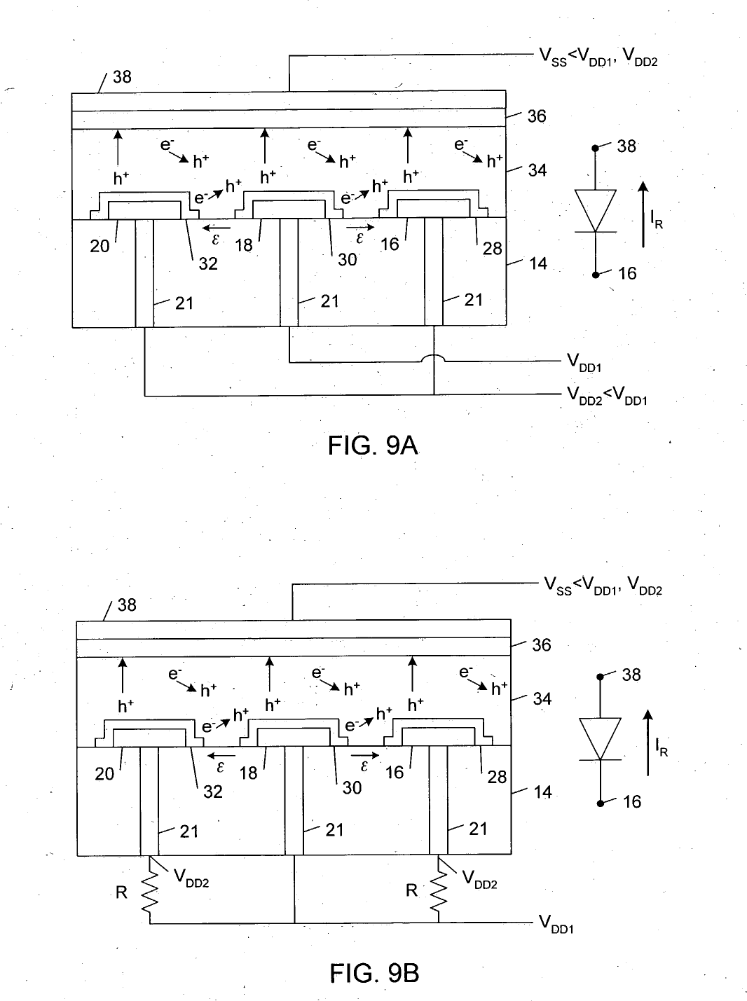

FIGS. 9A and 9B show the flow of charge carriers (e⁻, h⁺) in embodiments in which the bias circuit 58 induces carrier injection between photodiode regions to reduce image lag. In these embodiments, the bias circuit 58 applies voltages to the photodiode regions that induce carrier injection between pixels. The applied voltages may be applied between adjacent pixels or between non-adjacent pixels. In the illustrated embodiments, bias circuit 58 applies different bias voltages to adjacent pixel electrodes to generate inter-pixel electric fields (\vec{∈}) that inject electrons into the inter-pixel regions to annihilate holes and, thereby, increase the rate at which the residual charge is eliminated. In the illustrated embodiments, bias circuit 58 applies the same lower rail bias (V_{SS}) to each pixel of image sensor 10, but different rail biases (V_{DD1}, V_{DD2}) to adjacent pixel electrodes 16-20. In some implementations, the bias circuit 58 applies different high-to-low voltage ranges across adjacent pixels, while maintaining the same reverse bias voltage difference across each pixel of image sensor. For example, in one implementation, bias circuit 58 may apply a high:low voltage range of V_{DD1}:V_{SS1} to alternating pixels of image sensor 10 and a high:low voltage range of V_{DD2}:V_{SS2} to the adjacent set of alternative pixels, where V_{DD1}≠V_{DD2} and V_{SS1}≠V_{SS2} but V_{DD1}−V_{SS1}=V_{DD2}−V_{SS2}.

In the embodiment of FIG. 9A, the different bias voltages are applied to alternate pixel electrodes 16-20 by two separate bias lines (V_{DD1} and V_{DD2}). In the embodiment of FIG. 9B, the different bias voltages are applied to alternate pixel electrodes by a single bias line (V_{DD1}) and a set of resistors (R) that are coupled in parallel between the bias line and alternate pixel electrodes. Other biasing approaches also may be used to apply different bias voltages to adjacent pixels.

In some embodiments, the different voltages (e.g., V_{DD1} and V_{DD2}) applied to adjacent pixels are switched every cycle so that electrons are injected in both directions between adjacent pixels to more completely annihilate holes in the inter-pixel regions.

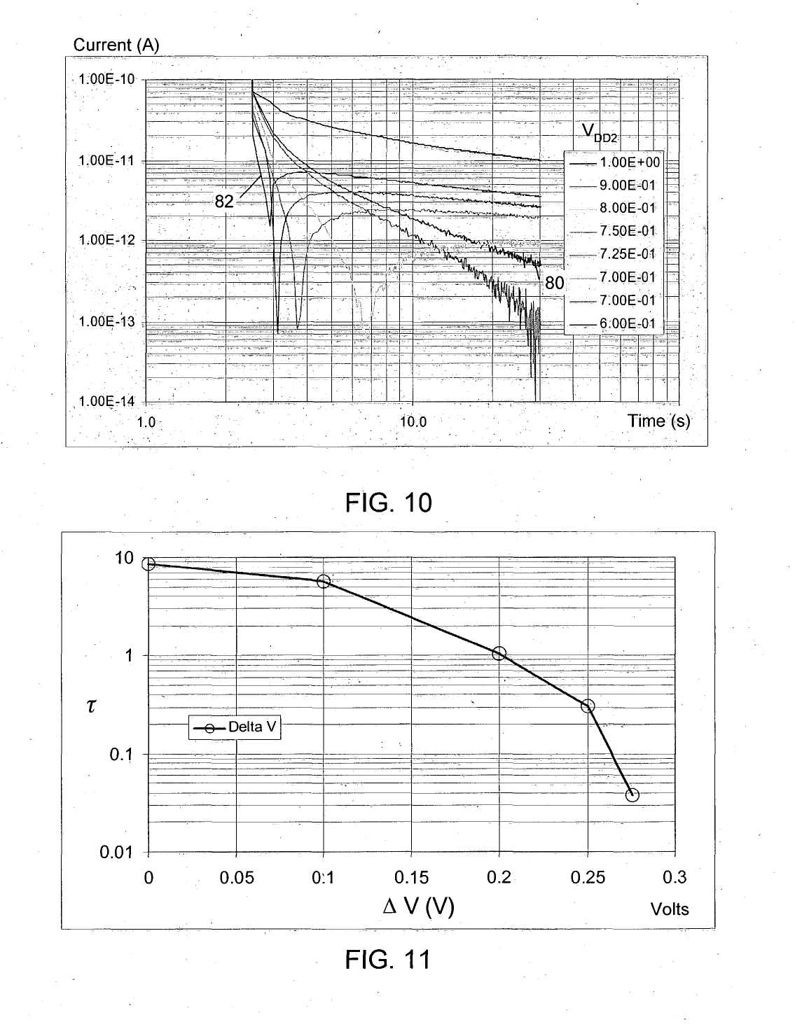

The measurement results of FIGS. 10 and 11 show that, in some implementations, image lag may be reduced substantially by applying a forward bias of only a few hundred millivolts. In particular, FIG. 10, shows the leakage current between a pixel electrode that is maintained at a bias of 1 volt (V_{DD1}) and an adjacent electrode with a bias voltage (V_{DD2}) that varies from 1 volt (line 80) to 400 millivolts (line 82). The characteristic decay time constant for the leakage current (I) may be modeled by the following equation:

$$I = {I}_{0} {ⅇ}^{- \frac{t}{τ}}$$

where I₀ is the current when the light source is removed, t is the time interval between the time the light source is removed and the times the measurements are made, I is the leakage current at time t, and τ is the characteristic decay time. Given two measurements during the current decay, it is possible to calculate τ without knowing I₀ using the following equation:

$$τ = \frac{{t}_{1} - {t}_{2}}{ln ( {I}_{2} ) - ln ( {I}_{1} )}$$

where t₁ and t₂ are two time intervals between the time the light source is removed and the times measurements are made, and I₁ and I₂ are the two current values at times t₁ and t₂, respectively. FIG. 11 shows that the characteristic decay time (τ) decreases as the magnitude of the inter-pixel bias (ΔV=V_{DD1}−V_{DD2}<0) increases (e.g., the characteristic decay time decreases by approximately ten-fold when the inter-pixel bias difference increases from 0 to 200 millivolts).

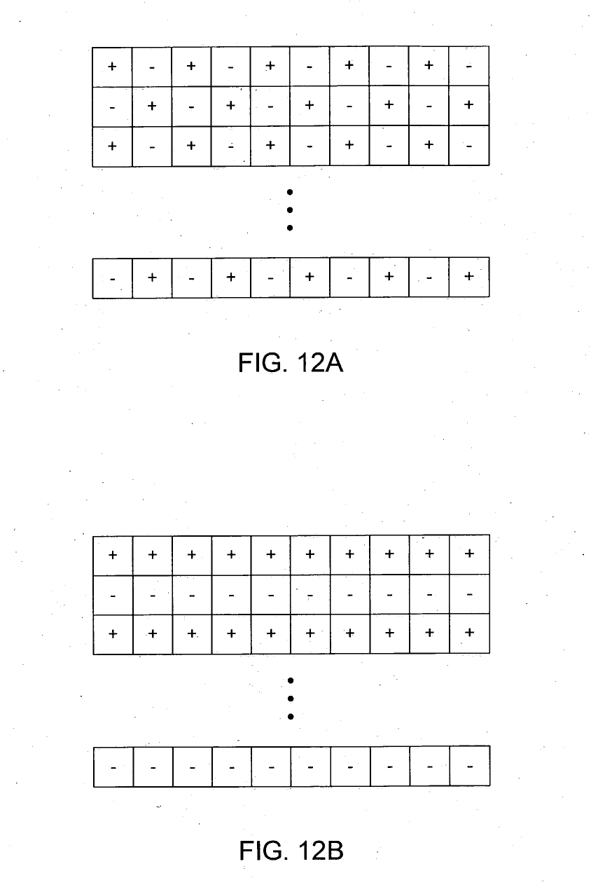

FIGS. 12A and 12B diagrammatically show top views of different implementations of the inter-pixel biasing approach of FIGS. 9A and 9B. In the embodiment of FIG. 12A, any given pixel has an adjacent row pixel and an adjacent column pixel with different relative bias levels (with higher and lower relative bias levels respectively indicated by “+” and “−”). In the embodiment of FIG. 12B, pixels in the same row have the same relative bias level, whereas pixels in adjacent rows have different relative bias levels.

Other embodiments are within the scope of the claims.

For example, the pixel photodiode regions in the embodiments described above have p-i-n photodiode structures from top to bottom. In other embodiments, the pixel photodiode regions may have n-i-p or any other photodiode structures. The pixel electrodes 16-20 also may be omitted, in which case the n-type regions 28-32 would correspond to the pixel electrodes.

The image lag reducing systems and methods described above are incorporated into image sensors having exemplary pixel sensing circuits and exemplary pixel sensing methods. These image lag reducing systems and methods readily may be incorporated into image sensors that have different pixel sensing circuits or that execute different pixel sensing methods, or both.

1. An image sensor, comprising:
multiple pixels each including a respective photodiode region;
pixel circuits each operable to control integration and readout steps for a respective pixel; and
a bias circuit operable to apply voltages across the pixels to induce carrier injection into the photodiode regions to reduce image lag.

2. The image sensor of claim 1, wherein the bias circuit is operable to induce forward bias flow of injected carriers through the pixel photodiode regions.

3. The image sensor of claim 2, wherein the bias circuit is operable to periodically induce forward bias flow of injected carriers through photodiode regions.

4. The image sensor of claim 3, wherein the pixel circuits and the bias circuit are cooperatively configured so that forward bias flow of injected carriers occurs during a reset step for each pixel.

5. The image sensor of claim 2, wherein pixels are arranged in an array of multiple rows and the bias circuit is operable to simultaneously induce forward bias flow of injected carriers through the photodiode regions of all pixels in a given row of the array.

6. The image sensor of claim 5, wherein the bias circuit is operable to simultaneously induce forward bias flow of injected carriers through the photodiode regions one row at a time.

7. The image sensor of claim 6, wherein the bias circuit is operable to simultaneously induce forward bias flow of injected carriers through photodiode regions of a given row before the pixel circuits in the given row initiate an integration step for the given row.

8. The image sensor of claim 5, wherein the bias circuit is operable to simultaneously induce forward bias flow of injected carriers through photodiode regions of all rows in the array.

9. The image sensor of claim 1, wherein the bias circuit is operable to induce carrier injection between photodiode regions of pixels.

10. The image sensor of claim 10, wherein the bias circuit is operable to induce carrier injection between photodiode regions of adjacent pixels.

11. The image sensor of claim 10, wherein the bias circuit is operable to apply different voltages levels to nodes of adjacent pixels.

12. The image sensor of claim 11, wherein the bias circuit is operable to apply different high-to-low voltage ranges across adjacent pixels.

13. The image of sensor of claim 11, wherein pixels are arranged in an array of multiple rows and the bias circuit is operable to apply different voltage levels to nodes of adjacent pixels in adjacent rows.

14. The image sensor of claim 11, wherein pixels are arranged in an array of rows and columns and the bias circuit is operable to apply different voltage levels to nodes adjacent pixels in adjacent rows and to apply different voltage levels to nodes of adjacent pixels in adjacent columns.

15. The image sensor of claim 10, wherein the different voltage levels applied to nodes of adjacent pixels are switched periodically.

16. The image sensor of claim 10, wherein the bias circuit includes two bias lines for applying different respective voltage levels to the pixels.

17. The image sensor of claim 10, wherein the bias circuit includes a bias line and a set of resistive elements respectively coupled in parallel between the bias line and alternate pixels.

18. A method of operating an image sensor comprising multiple pixels each including a respective photodiode region, the method comprising:
resetting photodiode regions;
integrating charge in photodiode regions;
sampling pixel nodes; and
inducing carrier injection into photodiode regions to reduce image lag.

19. The method of claim 18, wherein inducing carrier injection comprises inducing forward bias flow of carriers through the pixel photodiode regions.

20. The method of claim 18, wherein inducing carrier injection comprises inducing carrier injection between photodiode regions of adjacent pixels.
